(19) United States
(12) Patent Application Publication
(10) Pub. No.: US 2012/0149799 A1
(43) Pub. Date: Jun. 14, 2012

(54) CELLULOSIC UV CURABLE COMPOSITIONS AND ARTICLES

(76) Inventor: Mathew T. Stebbins, Woodbury, MN (US)

(21) Appl. No.: 13/292,172

(22) Filed: Nov. 9, 2011

Related U.S. Application Data
(60) Provisional application No. 61/421,677, filed on Dec. 10, 2010.

(51) Int. Cl. C08L 1/12; C08L 1/10; C08L 33/14; C08L 1/00

(52) U.S. Cl. 522/72; 524/35; 524/37; 524/41

(57) ABSTRACT

Cellulosic ultra-violet curable coating compositions, coatings and articles made from the compositions, and methods for making such coatings and articles and compositions are disclosed and claimed. Such coatings exhibit superior adhesion and hardness, without appreciable curl.

### CROSS REFERENCE TO RELATED APPLICATIONS

This application claims the benefit of U.S. Provisional Application No. 61/421,677, filed Dec. 10, 2010, entitled CELLULOSE UV CURABLE COMPOSITIONS AND ARTICLES, which is hereby incorporated by reference in its entirety.

### SUMMARY

At least one embodiment provides compositions comprising from about 14.3 weight percent to about 33.9 weight percent of at least one cured cellulosic polymer, from about 28.6 weight percent to about 48.2 weight percent of at least one cured radiation curable monomer, and from about 37.5 weight percent to about 57.1 weight percent of at least one cured heat curable monomer. The at least one cellulosic polymer may, in some cases, comprise a cellulose ester, such as, for example cellulose acetate butyrate. The at least one radiation curable monomer may, in some cases, comprise from about one to about six free-radically polymerizable groups, such as, for example, dipentaerythritol pentaacryalate. The at least one heat curable monomer may, in some cases, comprise at least about three ether groups, such as, for example, hexamethoxymethylmelamine. At least some embodiments provide articles comprising at least one layer comprising such compositions.

Other embodiments provide compositions comprising at least one cured cellulosic polymer, at least one cured radiation curable monomer, and at least one cured heat curable monomer, where the composition has an adhesion rating of 5, a pencil hardness of at least about 3H, and a curl of less than about 2.0 cm, when evaluated as a 4.0 to 8.0 g/m² cured layer on a 30 cm×30 cm×7.0 mil polyethylene terephthalate substrate. At least some embodiments provide articles comprising at least one layer comprising such compositions. Still other embodiments provide compositions comprising from about 15 parts by weight to about 52 parts by weight of a first composition comprising at least one cellulosic polymer and at least one radiation curable monomer, and from about 25 parts by weight to about 30 parts by weight of at least one heat curable polymer. In some cases, the weight ratio of the at least one cellulosic polymer to the at least one radiation curable monomer may be, for example, from about 1:10 to about 10:1. Such a composition may, in some cases, further comprise at least one solvent comprising at least one ketone, ester, or alcohol, such as, for example, one or more of methyl ethyl ketone, butyl acetate, and ethanol. Such a composition may, in some cases, further comprise one or more photoinitiators or thermal curing catalysts. At least some embodiments provide layers formed by methods comprising providing and curing such compositions to form a layer. In some cases, such layers have an adhesion rating of 5, a pencil hardness of at least about 3H, and a curl of less than about 2.0 cm, when evaluated as a 4.0 to 8.0 g/m² cured layer on a 30 cm×30 cm×7.0 mil polyethylene terephthalate substrate. At least some embodiments provide articles comprising at least one such layer.

These and other embodiments will be understood from the description, exemplary embodiments, examples, and claims that follow.

### DESCRIPTION

All publications, patents, and patent documents referred to in this document are incorporated by reference in their entirety, as though individually incorporated by reference.

U.S. Provisional Application No. 61/421,677, filed Dec. 10, 2010, entitled CELLULOSIC UV CURABLE COMPOSITIONS AND ARTICLES, is hereby incorporated by reference in its entirety. UV curable hardcoats are known. See, for example, Koleske, J. V., Coatings Technology, 1997, 69(866), 29; U.S. Pat. No. 7,339,793; and US patent application publication 2009/0274902; each of which is hereby incorporated by reference in its entirety. Unsaturated polyesters can possess high molecular weights and high crosslink densities upon exposure to ultraviolet radiation, which can result in improved coating durability. Monomeric and functional acrylates can have molecular weights of 10,000 g/mol or less, typically 5,000 g/mol or less. Applicants have found that addition of higher molecular weight species, such as cellulosic polymers, can enhance coating flexibility and substrate adhesion. Such coatings may be applied to flexible substrates, such as, for example, polyethylene terephthalate, other polyesters, polycarbonates, and the like. Such coated substrates may be useful when incorporated into articles, such as electronic devices.

Cellulosic polymers are polysaccharides or derivatives of polysaccharides, that may have degrees of polymerization of, for example, 100, 1000, 10,000, or more. These include derivatives of cellulose, such as, for example, esters and ethers of cellulose. Cellulosic esters include cellulose acetates, such as, for example, cellulose acetate, cellulose triacetate, cellulose propionate, cellulose acetate propionate, cellulose acetate butyrate (CAB), and the like. Cellulosic ethers include, for example, methylcellulose, ethylcellulose, ethyl methyl cellulose, hydroxyethyl cellulose, hydroxypropyl cellulose, hydroxyethyl methyl cellulose, hydroxypropyl methyl cellulose, ethyl hydroxyethyl cellulose, carboxymethyl cellulose, and the like. These and other such cellulosic polymers will be understood by those skilled in the art.

Radiation curable monomers are known. These may include monomers with one or more acrylic or methacrylic groups, such as, for example, polyfunctional monomers with two, three, four, five, six, or more polymerizable groups. In some cases, radiation curable monomers may be polymerized or crosslinked in the presence of light, such as, for example, ultraviolet light at wavelengths of, for example, about 246 nm or about 280 nm. Dipentaerythritol pentaacrylate (DPPA) is an exemplary radiation curable monomer. This and other such monomers will be understood by those skilled in the art.

Heat curable monomers are known. These may, for example, include monomers with one or more ether groups, such as two, three, or more ether groups. Such ether groups may include, for example, one or more methoxy, ethoxy, or other groups. Such ether groups may with other functional groups, such as, for example, hydroxyl groups, or they may react with other ether groups. Such reactions may result in polymerization or crosslinking. Heat curable monomers with aromatic or heteroaromatic rings, such as, for example, functionalized melamines, may provide improved coating compatibility with such substrates as polyethylene terephthalate. Hexamethyoxymethylamine (HMMM) is an exemplary heat curable monomer. This and other such monomers will be understood by those skilled in the art.

Organic solvents are known. These may be used for such purposes as controlling solution viscosity, improving wetting and substrate coating, and the like. Examples of organic solvents include ketones, esters, and alcohols, such as, for example, methyl ethyl ketone (MEK), butyl acetate (BA), ethanol, or mixtures of these. These and other such organic solvents will be understood by those skilled in the art.

Radiation and thermal curing may be aided through use of photoinitators, thermal initiators, acid catalysts, and the like. Coating surface properties may be aided through use of surfactants, such as, for example, fluoroacrylates. These and other coating additives will be understood by those skilled in the art.

The applicant has discovered that useful hardcoat layers may be formed from UV curable mixes containing cellulose polymers. Such layers can exhibit superior hardness, adhesion, and dimensional stability when used on flexible substrates. Exemplary UV curable mixes may, for example, comprise 5-50 wt % CAB, 5-50 wt % DPPA, 10-20 wt % MEK, 10-20 wt % BA, 1-10 wt % ethanol, 25-30% HMMM, 0.1-1.0 wt % benzophenone, 0.2-2.0 wt % 1-hydroxycyclophenyl ketone, 0.01-0.02 wt % fluorinated oxetane acrylate, and 1-2 wt % PTSA.

UV curable mixes may be coated onto substrates using any suitable methods, including, for example, dip-coating, wound-wire rod coating, doctor blade coating, air knife coating, gravure roll coating, reverse-roll coating, slide coating, bead coating, extrusion coating, curtain coating, and the like. Examples of some coating methods are described in, for example, Research Disclosure, No. 308119, December 1989, pp. 1007-08, (available from Research Disclosure, 145 Main St., Ossining, N.Y., 10562, http://www.researchdisclosure.com), which is hereby incorporated by reference in its entirety. Such coatings may be dried prior to curing, for example, they may be dried at about 121° C. for about 2 minutes.

### Exemplary Embodiments

U.S. Provisional Application No. 61/421,677, filed Dec. 10, 2010, entitled CELLULOSIC UV CURABLE COMPOSITIONS AND ARTICLES, which is hereby incorporated by reference in its entirety, disclosed the following 19 non-limiting exemplary embodiments:

A. A composition comprising from about 14.3 weight percent to about 33.9 weight percent of at least one cured cellulosic polymer, from about 28.6 weight percent to about 48.2 weight percent of at least one cured radiation curable monomer, and from about 37.5 weight percent to about 57.1 weight percent of at least one cured heat curable monomer.
B. The composition according to embodiment A, wherein the at least one cellulosic polymer comprises at least one cellulose ester.
C. The composition according to embodiment A, wherein the at least one cellulosic polymer comprises cellulose acetate butyrate.
D. The composition according to embodiment A, wherein the at least one radiation curable monomer comprises from about one to about six free-radically polymerizable groups.
E. The composition according to embodiment A, wherein the at least one radiation curable monomer comprises dipentaerythritol pentaacrylate.
F. The composition according to embodiment A, wherein the at least one heat curable monomer comprises at least about three ether groups.
G. The composition according to embodiment A, wherein the at least one heat curable monomer comprises hexamethoxymethylmelamine.
H. An article comprising at least one layer comprising the composition according to embodiment A.
J. A composition comprising at least one cured cellulosic polymer, at least one cured radiation curable monomer, and at least one cured heat curable monomer, wherein the composition has an adhesion rating of 5, a pencil hardness of at least about 3H, and a curl of less than about 2.0 cm, when evaluated as a 4.0 to 8.0 g/m² cured layer on a 30 cm×30 cm×7.0 mil polyethylene terephthalate substrate.
K. An article comprising at least one layer comprising the composition of embodiment J.
L. A composition comprising:

from about 15 parts by weight to about 52 parts by weight of a first composition comprising at least one cellulosic polymer and at least one radiation curable monomer; and

from about 25 parts by weight to about 30 parts by weight of at least one heat curable monomer.

M. The composition according to embodiment L, wherein the weight ratio of the at least one cellulosic polymer to the at least one radiation curable monomer is from about 1:10 to about 10:1.
N. The composition according to embodiment L, further comprising at least one solvent comprising at least one ketone, ester, or alcohol.
P. The composition according to embodiment L, wherein the at least one solvent comprises one or more of methyl ethyl ketone, butyl acetate, and ethanol.
Q. The composition according to embodiment L, further comprising at least one photoinitiator.
R. The composition according to embodiment L, further comprising at least one thermal curing catalyst.
S. A layer formed by a method comprising providing the composition according to embodiment L and curing the composition.
T. The layer according to embodiment S having an adhesion rating of 5, a pencil hardness of at least about 3H, and a curl of less than about 2.0 cm, when evaluated as a 4.0 to 8.0 g/m² cured layer on a 30 cm×30 cm×7.0 mil polyethylene terephthalate substrate.
U. An article comprising at least one layer according to embodiment S.

### EXAMPLES

### Example 1

### Preparation of Mixes

A cellulose polymer premix was first prepared. To a room temperature mixing vessel was added 46.25 parts by weight methyl ethyl ketone (>99% purity) and 46.25 parts by weight butyl acetate (>98% purity). To the premix was added 7.50 parts by weight cellulose acetate butyrate (CAB-551-0.2, Eastman) with agitation. The premix continued to be stirred for 3-4 hrs, which was sufficient time for no gel particles to be visible at 80-100 power magnification in samples take from the premix. Additional methyl ethyl ketone and butyl acetate were added to make up for evaporative losses during mixing.

A photoinitiator premix was prepared by adding 8.3 parts by weight of benzophenone (BP, Dalian) to 16.7 parts by weight of 1-hydroxycyclohexylphenyl ketone (X-CURE 184, Dalian). To this premix was added 75.0 parts by weight of methyl ethyl ketone (>99% purity). This premix was shaken for 20 min at room temperature.

A fluoroacrylate premix was prepared by adding 90.0 parts by weight of methyl ethyl ketone (>99% purity) to 10.0 parts by weight of fluorinated oxetane acrylate (Polyfox PF-3320, Omnova). This premix was shaken for 20 min at room temperature.

A PTSA premix was prepared by adding 80.0 parts by weight of denatured ethanol (CCDA A1, 200 proof) to 20.0 parts by weight of p-toluene sulfonic acid (PTSA) (Fisher). This premix was shaken for 20 min at room temperature.

To a clean vessel, 47.19 parts by weight of the cellulose polymer premix, 3.29 parts by weight of the photoinitiator premix, 0.17 parts by weight of the fluoroacrylate premix, 13.21 parts by weight of methyl ethyl ketone (>99% purity), 13.20 parts by weight of butyl acetate (>98% purity), 9.4 parts by weight dipentaerythritolpentaacrylate (DPPA), and 10.64 parts by weight of hexamethoxymethylmelamine (HMMM) were added. The resulting mix was stirred for 20 minutes. To this mix 2.90 parts by weight of the PTSA premix were then added with stirring. The resulting coating mix was filtered prior to use.

### Preparation of Coatings

The coating mix was applied to a 7.0 mil polyethylene terephthalate substrate, dried at 121° C. for 2 min, and exposed to 246 nm and 280 nm ultraviolet radiation at 600 watts per inch intensity for 0.1-0.2 sec. The resulting dry coating weight was in the range of 4.0-8.0 g/m².

### Coating Evaluation

Adhesion of the coating to the polyethylene terephthalate substrate was evaluated according to ASTM 3359 Standard Test Method for Measuring Adhesion by Tape. A cross-hatched area was scribed on the coating with a razor blade and gently removing the debris with a lint-free cotton pad. Adhesive tape (#610 semi-transparent pressure-sensitive tape from 3M Company, St. Paul, Minn.) was then applied to the crosshatched area and smoothed with a rubber roller until there were no air bubbles between the tape and the coated film. The tape was then rapidly peeled off. The appearance of the coated film was given a score on a 0 to 5 scale: 5=edges of scribed cuts completely smooth; 4=flakes of coating detached at some intersections of scribed lines, with less than about 5% of the test area being affected; 3=flakes of coating detached along some edges and at some intersections of scribed lines, with about 5 to 15% of the test area being affected; 2=flakes of coating detached along some edges of scribed lines and on parts of the squares, with about 15 to 35% of the test area being affected; 1=coating detached along the edges of scribed lines in large ribbons, with more than about 35% of the test area being affected; 0=coating completely removed. This coating achieved an adhesion rating of 5.

Pencil hardness of the coating was measured according to

ASTM 3363 Standard Test Method for Film Hardness by Pencil. The method reports the hardest standard pencil lead that does not mar the coating when pushing a pencil away from the operator and where the pencil is oriented at a 45° angle away from the operator. This coating achieved a pencil hardness score of 3H.

A 30 cm×30 cm portion of the coated polyethylene terephthalate substrate was evaluated for curl. The substrate was placed on a horizontal surface and heated to 149° C. for 5 min. It was then allowed to cool to ambient temperature. The deflections of the four corners of the substrate from the horizontal surface were measured, with the largest value being recorded. The curl for this coating was 1.5 cm.

### Examples 2-12

Several additional coatings of varying composition were prepared and evaluated according to the procedures of Example 1. A coating made from a mix containing no cellulose acetate butyrate had severe defects. The resulting dry coating weights of the other samples were in the range of 4.0-8.0 g/m². The compositions and measured properties are summarized in Table I.

The data of Table I show that coatings comprising at least about 37.5 wt % of the cured heat curable HMMM monomer achieved an adhesion rating of 5, coatings comprising at least about 40.3 wt % of the cured radiation curable DPPA monomer achieved a pencil hardness of at least about 3H, and that coatings comprising at least about 14.3 wt % of the cured cellulosic CAB polymer achieved a curl of less than about 2.0 cm.

The invention has been described in detail with respect to particular embodiments, but it will be understood that variations and modifications can be effected within the scope of the invention. The presently disclosed embodiments are therefore considered in all respects to be illustrative and not restrictive. The scope of the invention is indicated by the appended claims, and all changes that come within the meaning and range of equivalents thereof are intended to be embraced within.

TABLE I

| | HMMM | CAB | DPPA | | | |
|---|---|---|---|---|---|---|
| | Cured | Cured | Cured | | | |
| | Coating | Coating | Coating | | | |
| | Weight | Weight | Weight | Pencil | Adhesion | Curl |
| Sample | Fraction | Fraction | Fraction | Hardness | Rating | (cm) |
| Ex. 1 | 44.78% | 14.93% | 40.30% | 3H | 5 | 1.50 |
| Ex. 2 | 42.86% | 14.29% | 42.86% | 4H | 5 | 2.00 |
| Ex. 3 | 50.00% | 16.67% | 33.33% | 2H | 5 | 1.00 |
| Ex. 4 | 37.50% | 25.00% | 37.50% | 2H | 5 | 1.20 |
| Ex. 5 | 42.86% | 28.57% | 28.57% | 1H | 5 | 0.75 |
| Ex. 6 | 33.33% | 16.67% | 50.00% | 5H | 3 | 1.75 |
| Ex. 7 | 33.33% | 33.33% | 33.33% | 2H | 4 | 0.50 |
| Ex. 8 | 28.57% | 42.86% | 28.57% | 1H | 4 | 0.20 |
| Ex. 9 | 18.18% | 9.09% | 72.73% | 6H | 1 | 10.00 |
| Ex. 10 | 22.22% | 11.11% | 66.67% | 6H | 2 | 5.00 |
| Ex. 11 | 14.29% | 28.57% | 57.14% | 5H | 1 | 0.75 |
| Ex. 12** | 50.00% | 0.00% | 50.00% | 6H | 5 | 15.00 |

**Example 12 contained no CAB in the coating mix. The coating had severe defects.

What is claimed:

1. A composition comprising from about 14.3 weight percent to about 33.9 weight percent of at least one cured cellulosic polymer, from about 28.6 weight percent to about 48.2 weight percent of at least one cured radiation curable monomer, and from about 37.5 weight percent to about 57.1 weight percent of at least one cured heat curable monomer.

2. The composition according to embodiment 1, wherein the at least one cellulosic polymer comprises at least one cellulose ester.

3. The composition according to embodiment 1, wherein the at least one cellulosic polymer comprises cellulose acetate butyrate.

4. The composition according to embodiment 1, wherein the at least one radiation curable monomer comprises from about one to about six free-radically polymerizable groups.

5. The composition according to embodiment 1, wherein the at least one radiation curable monomer comprises dipentaerythritol pentaacrylate.

6. The composition according to embodiment 1, wherein the at least one heat curable monomer comprises at least about three ether groups.

7. The composition according to embodiment 1, wherein the at least one heat curable monomer comprises hexamethoxymethylmelamine.

8. An article comprising at least one layer comprising the composition according to embodiment 1.

9. A composition comprising at least one cured cellulosic polymer, at least one cured radiation curable monomer, and at least one cured heat curable monomer, wherein the composition has an adhesion rating of 5, a pencil hardness of at least about 3H, and a curl of less than about 2.0 cm, when evaluated as a 4.0 to 8.0 g/m² cured layer on a 30 cm×30 cm×7 0 mil polyethylene terephthalate substrate.

10. An article comprising at least one layer comprising the composition of embodiment 9.

11. A composition comprising:
from about 15 parts by weight to about 52 parts by weight of a first composition comprising at least one cellulosic polymer and at least one radiation curable monomer; and
from about 25 parts by weight to about 30 parts by weight of at least one heat curable monomer.

12. The composition according to embodiment 11, wherein the weight ratio of the at least one cellulosic polymer to the at least one radiation curable monomer is from about 1:10 to about 10:1.

13. The composition according to embodiment 11, further comprising at least one solvent comprising at least one ketone, ester, or alcohol.

14. The composition according to embodiment 11, wherein the at least one solvent comprises one or more of methyl ethyl ketone, butyl acetate, and ethanol.

15. The composition according to embodiment 11, further comprising at least one photoinitiator.

16. The composition according to embodiment 11, further comprising at least one thermal curing catalyst.

17. A layer formed by a method comprising providing the composition according to embodiment 11 and curing the composition.

18. The layer according to embodiment 17 having an adhesion rating of 5, a pencil hardness of at least about 3H, and a curl of less than about 2.0 cm, when evaluated as a 4.0 to 8.0 g/m² cured layer on a 30 cm×30 cm×7.0 mil polyethylene terephthalate substrate.

19. An article comprising at least one layer according to embodiment 17.
